(19) United States
(12) Patent Application Publication
(10) Pub. No.: US 2014/0323086 A1
(43) Pub. Date: Oct. 30, 2014

(54) MANAGEMENT OF WIRELESS CHANNEL USE

(71) Applicant: HEWLETT-PACKARD DEVELOPMENT COMPANY, L.P., Houston, TX (US)

(72) Inventors: Theodore J. Wheeler, Roseville, CA (US); Kenneth M. Klingler, Roseville, CA (US)

(73) Assignee: Hewlett-Packard Development Company, L.P., Houston, TX (US)

(21) Appl. No.: 13/872,915

(22) Filed: Apr. 29, 2013

(51) Int. Cl. H04W 72/04; H04W 12/08

(52) U.S. Cl. CPC H04W 72/048; H04W 12/08
USPC 455/411

(57) ABSTRACT

According to an example, geographic locations of a wireless communication apparatus and an installation at which use of a predetermined channel is authorized, in which the predetermined channel corresponds to a predetermined range of frequencies that are unauthorized for public use may be determined. In addition, a determination may be made as to whether the wireless communication apparatus is outside of a predefined distance from the installation. Moreover, in response to a determination that the wireless communication apparatus is outside of the predefined distance, the wireless communication apparatus may be allowed to use the predetermined channel and in response to a determination the wireless communication apparatus is within the predetermined distance, the wireless communication apparatus may be restricted in its use of the predetermined channel.

### BACKGROUND

The wireless local area network (WLAN) channels over which wireless devices are allowed to operate using Institute of Electrical and Electronics Engineers (IEEE) 802.11 standards are typically regulated by each country's government. In the United States, to avoid interference with weather-radar and military applications, the Federal Communications Commission (FCC) requires that devices operating on 5.250-5.350 GHz and 5.470-5.725 GHz employ dynamic frequency selection (DFS) and transmit power control (TPC) capabilities. The FCC also eliminated the use of WLAN channels 120, 124, and 128 to avoid interference with Terminal Doppler Weather Radar (TDWR) systems.

### BRIEF DESCRIPTION OF THE DRAWINGS

Features of the present disclosure are illustrated by way of example and not limited in the following figure(s), in which like numerals indicate like elements, in which:

FIG. 1 depicts a simplified block diagram of a wireless communication apparatus, according to an example of the present disclosure;

FIG. 2 depicts a simplified block diagram of a wireless communication environment including the wireless communication apparatus depicted in FIG. 1, according to an example of the present disclosure;

FIG. 3 depicts a flow diagram of a method of managing use of a predetermined channel by a wireless communication apparatus, according to an example of the present disclosure; and

FIG. 4 illustrates a schematic representation of an electronic device, which may be employed to perform various functions of the wireless communication apparatus depicted in FIGS. 1 and 2, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are a method and wireless communication apparatus to manage use of a predetermined wireless channel based upon a proximity of the apparatus to an installation at which use of the wireless is authorized. In other words, the method and apparatus disclosed herein may manage use of a wireless channel that may be restricted from use outside of predetermined installations or locations. By way of example, the predetermined channel is one of WLAN channels 120, 124, and 128, which are prohibited from use at locations other than installations that implement TDWR systems. In another example, the predetermined channel is a channel in the 5.250-5.350 GHz and 5.470-5.725 GHz frequencies, which may require that dynamic frequency selection (DFS), transmit power control (TPC), and a 60-second availability check be employed to use these channels. As discussed herein, the apparatus may only use WLAN channels 120, 124, and 128 when the apparatus is of sufficient distance from any of the installations to prevent or minimize the risk of interference with systems in those installations that may operate at frequencies corresponding to those WLAN channels. These frequencies may include, for instance, frequencies in the 5600-5650 MHz spectrum. As also discussed herein, the apparatus may use the WLAN channels corresponding to the 5.250-5.350 GHz and 5.470-5.725 GHz frequencies without having to employ the 60-second channel availability check when the apparatus is of sufficient distance from any of the installations to prevent or minimize the risk of interference with systems in those installations that may operate at frequencies corresponding to those WLAN channels.

As is generally known, the spectrum available for wireless communications is very limited. Through implementation of the method and apparatus disclosed herein, the number of WLAN channels available for use by an apparatus, such as an access point, may be substantially increased. In addition, the determination as to whether the apparatus is located at a sufficient distance from the installations may be made automatically, e.g., without user intervention, to substantially minimize the likelihood that the predetermined WLAN channels are used in violation of the proximity requirements disclosed herein.

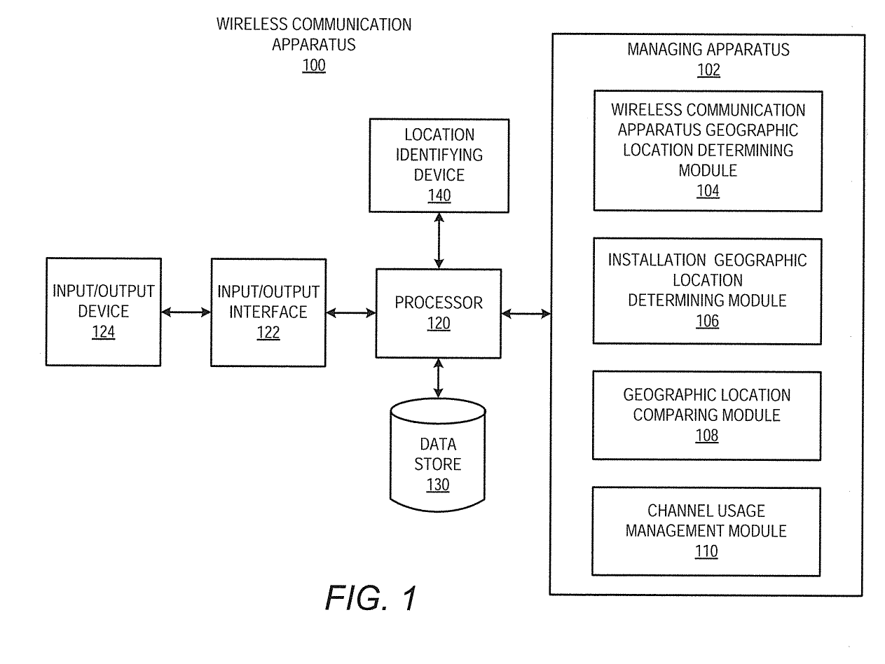

With reference first to FIG. 1, there is shown a simplified block diagram of a wireless communication apparatus 100, which may implement various features disclosed herein, according to an example. It should be understood that the wireless communication apparatus 100 may include additional elements and that some of the elements depicted therein may be removed and/or modified without departing from a scope of the wireless communication apparatus 100.

The wireless communication apparatus 100 is depicted as including a managing apparatus 102, a processor 120, an input/output interface 122, an input/output device 124, a data store 130, and a location identifying device 140. The managing apparatus 102 is also depicted as including a wireless communication apparatus geographic location determining module 104, an installation geographic location determining module 106, a geographic location comparing module 108, and a channel usage management module 110.

The processor 120, which may be a microprocessor, a micro-controller, an application specific integrated circuit (ASIC), and the like, is to perform various processing functions in the wireless communication apparatus 100. One of the processing functions may include invoking or implementing the modules 104-110 of the managing apparatus 102 as discussed in greater detail herein below. According to an example, the managing apparatus 102 is a hardware device, such as, a circuit or multiple circuits arranged on a board. In this example, the modules 104-110 may be circuit components or individual circuits.

According to another example, the managing apparatus 102 is a hardware device, for instance, a volatile or non-volatile memory, such as dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like, on which software may be stored. In this example, the modules 104-110 may be software modules stored in the managing apparatus 102. According to a further example, the modules 104-110 may be a combination of hardware and software modules.

The processor 120 may store data in the data store 130 and may use the data in implementing the modules 104-110. The data store 130 may be volatile and/or non-volatile memory, such as DRAM, EEPROM, MRAM, phase change RAM (PCRAM), Memristor, flash memory, and the like. In addition, or alternatively, the data store 130 may be a device that may read from and write to a removable media, such as, a floppy disk, a CD-ROM, a DVD-ROM, or other optical or magnetic media.

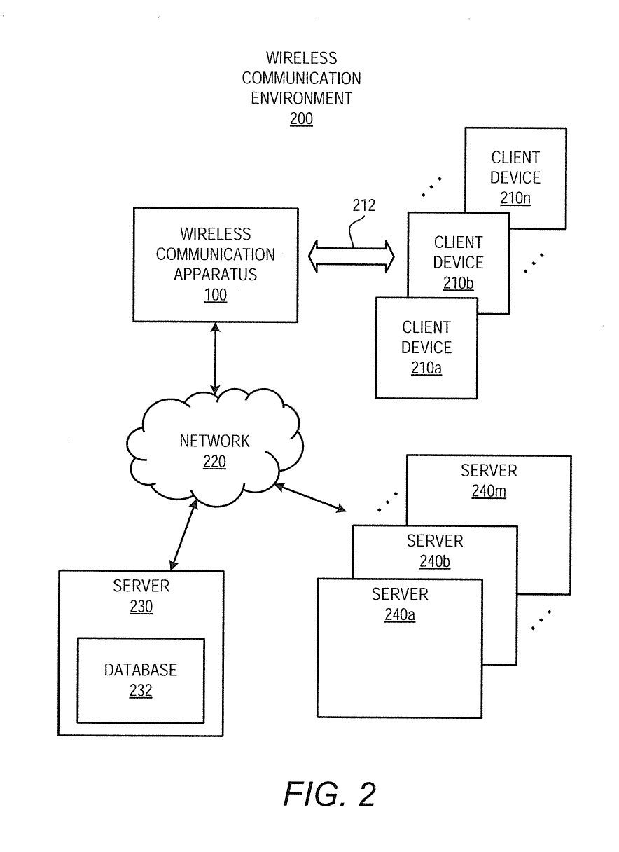

The input/output interface 122 may include hardware and/or software to enable the wireless communication apparatus 100 to communicate wirelessly with a client device (shown in FIG. 2). In addition, the input/output device 124 may be an antenna through which signals may be wirelessly communicated to and from the client device.

According to another example, the input/output interface 122 includes hardware and/or software to enable the wireless communication apparatus 100 to communicate either through a wired or wireless connection to a network (shown in FIG. 2), such as the Internet, a local area network, a wide area network, etc. The wireless communication apparatus 100 may, according to an example, be a wireless access point that facilitates communications between the client device and a network. By way of example, a client device may access the Internet through the wireless communication apparatus 100. In other examples, the wireless communication apparatus 100 is a different type of electronic device, such as a cellular telephone, a computer, etc.

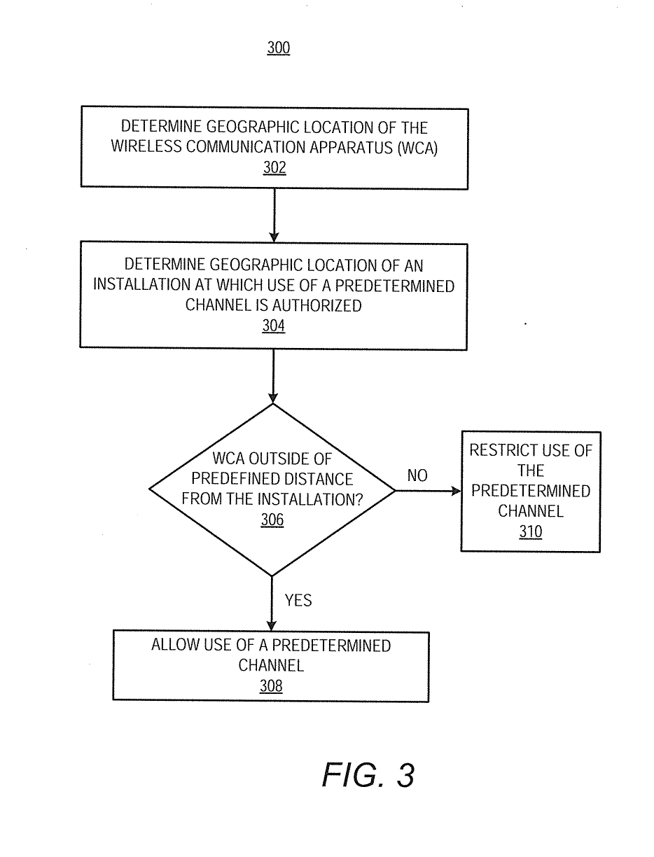

Various manners in which the managing apparatus 102 in general and the modules 104-110 in particular may be implemented are discussed in greater detail with respect to the method 300 depicted in FIG. 3. Prior to discussion of the method 300, however, reference is made first to FIG. 2, in which is shown a simplified block diagram of a wireless communication environment 200 including the wireless communication apparatus 100 depicted in FIG. 1, according to an example. It should be understood that the wireless communication environment 200 may include additional elements and that some of the elements depicted therein may be removed and/or modified without departing from a scope of the wireless communication environment 200.

As shown in FIG. 2, the wireless communication apparatus 100 may communicate wirelessly with a number of client devices 210a-210n, in which the variable “n” denotes an integer greater than one, as indicated by the arrow 212. The wireless communication apparatus 100 is also depicted as being connected to a network 220, which is further depicted as being connected to a server 230 having a database 232. The network 220 is still further depicted as being in a location with a plurality of additional servers 240a-240m, in which the variable “m” denotes an integer greater than one.

The client devices 210a-210n may be electronic devices such as laptop computers, tablet computers, personal digital assistants, cellular telephones, desktop computers, etc. In addition, the servers 240a-240m may be servers that provide content over the Internet. Thus, for instance, the wireless communication apparatus 100 may function as a wireless access point, such as a wireless hotspot, through which the client devices 210a-210n may access the servers 240a-240m through the network 220, which may be the Internet.

According to an example, the wireless communication apparatus 100 may comply with IEEE 802.11 standards in facilitating connections between the client devices 210a-210n and the network 220 over WiFi. As such, the WLAN channels over which the wireless communication apparatus 100 may communicate with the client devices 210a-210n may substantially be limited to those channels corresponding to the set of frequencies that have been made available for these types of communications by a governmental agency, such as the FCC in the United States. In addition, in the United States, as well as in various other countries, wireless communication devices are currently prohibited from using WLAN channels 120, 124, and 128 to avoid interference with Terminal Doppler Weather Radar (TWDR) systems. Wireless communication devices are also required to perform DFS, TPC, and a 60-second availability check prior to using channels in the 5.250-5.350 GHz and 5.470-5.725 GHz frequencies. Generally speaking, TDWR systems are Doppler weather radar systems that are primarily used for the detection of hazardous wind shear conditions on and near major airports.

As discussed herein, the wireless communication apparatus 100 may determine its position relative to such installations and if a determination is made that the wireless communication apparatus 100 is outside of a predefined distance from these types of installations, the wireless communication apparatus 100 may allow the restricted or prohibited WLAN channels to be used. That is, the wireless communication apparatus 100 may allow WLAN channels 120, 124, and 128 to be used along with the other permitted WLAN channels. In addition, or alternatively, the wireless communication apparatus 100 may allow use of channels corresponding to the 5.250-5.350 GHz and 5.470-5.725 GHz frequencies without having to perform the 60-second availability check. In this regard, the wireless communication apparatus 100 may have a relatively larger number of WLAN channels to use in communicating with the client devices 210a-210n than is currently available through compliance with IEEE 802.11 standards.

Turning now to FIG. 3, there is shown a flow diagram of a method 300 of managing use of a predetermined channel by a wireless communication apparatus 100, according to an example. It should be apparent to those of ordinary skill in the art that the method 300 represents a generalized illustration and that other operations may be added or existing operations may be removed, modified, or rearranged without departing from a scope of the method 300. Although particular reference is made to the wireless communication apparatus 100 depicted in FIGS. 1 and 2 as being an apparatus that may implement the operations described in the method 300, it should be understood that the method 300 may be performed in differently configured apparatuses without departing from a scope of the method 300.

At block 302, a geographic location of the wireless communication apparatus 100 may be determined. For instance, the wireless communication apparatus geographic location determining module 104 may determine the geographic location, such as longitude and latitude coordinates, of the wireless communication apparatus 100 through receipt of location identifying information from the location identifying device 140. In one example, the location identifying device 140 is a global positioning system (GPS) device that is able to determine its location. In other examples, the location identifying device 140 is another type of device that is able to determine its location through information obtained from satellites, cellular telephone towers, sensors that may be used to triangulate a position of the location identifying device 140, etc.

In another example, the wireless communication apparatus geographic location determining module 104 may receive coordinates of the geographic location of the wireless communication apparatus 100 from an external source. For instance, a user may manually supply the geographic location coordinates of the wireless communication apparatus 100. In addition or alternatively, the wireless communication apparatus geographic location determining module 104 may receive the geographic location coordinates of the wireless communication apparatus 100 from an external device that is aware of its geographic location coordinates.

At block 304, a geographic location of an installation at which use of the predetermined channel is authorized may be determined, in which the predetermined channel corresponds to a predetermined range of frequencies that are restricted for public use. The term “restricted” may be defined as prohibited and/or requiring performance of additional operations to use the predetermined channel. The installation geographic location determining module 106 may, for instance, determine the location of a TWDR installation or locations of TWDR installations. According to an example, the installation geographic location determining module 106 may make this determination from publicly available information. For instance, a publicly accessible database 232 containing a list of the TWDR installations and their geographic locations may be accessed through communication with a server 230 containing or having access to the database 232. That is, the wireless communication apparatus 100 may communicate with the server 230 over the network 220 to access the list of the TWDR installation geographic locations. In addition, the database 232 may be updated to identify changes to the TVVDR installations and their geographic locations.

At block 306, a determination is made as to whether the wireless communication apparatus 100 is outside of a predefined distance from the installation. For instance, the geographic location comparing module 108 may identify the installation to which the wireless communication apparatus 100 is in closest proximity and may determine the distance from the wireless communication apparatus 100 to that installation. In addition, the geographic location comparing module 108 may determine whether the determined distance is outside of a predefined distance from that installation.

By way of example, the predefined distance may be selected to substantially ensure that there is little or no interference between the use of the restricted (or prohibited) channels by the wireless communication apparatus 100 and the use of those channels by systems in the installation. A distance of at least 20 miles may be sufficient to meet this requirement, which is the distance enumerated by the FCC for avoidance of interference in other devices that operate in the 5 GHz band. According to a particular example, the predefined distance is approximately 30 miles.

In response to a determination that the wireless communication apparatus 100 is outside of the predefined distance from the installation, the wireless communication apparatus may be allowed to use the predetermined channel as indicated at block 308. Thus, for instance, the channel usage management module 110 may be permitted to use the predetermined channel along with the other permitted channels in providing WiFi services to the client devices 210a-210n. By way of particular example, the channel usage management module 110 may be permitted to use WLAN channels 120, 124, and 128. In another example in which the predetermined channel corresponds to a channel in the 5.250-5.350 GHz and 5.470-5.725 GHz frequencies, the channel usage management module 110 may be permitted to use the predetermined channel without performing the 60-second availability check, which may substantially reduce the amount of time in providing wireless access point services.

However, in response to a determination that the wireless communication apparatus 100 is within the predetermined distance, the wireless communication apparatus 100 may be restricted in its use of the predetermined channel. Thus, for instance, the channel usage management module 110 may not be permitted to use the predetermined channel in providing WiFi services to the client devices 210a-210n. As such, the channel usage management module 110 may only use the WLAN channels permitted under IEEE 802.11. In other examples, the channel usage management module 110 may be required to perform the 60-second availability check prior to using channels in the 5.250-5.350GHz and 5.470-5.725 GHz frequencies, which may substantially increase the amount of time required to perform wireless access point services over use of other available channels.

Some or all of the operations set forth in the method 300 may be contained as a utility, program, or subprogram, in any desired computer accessible medium. In addition, the method 300 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

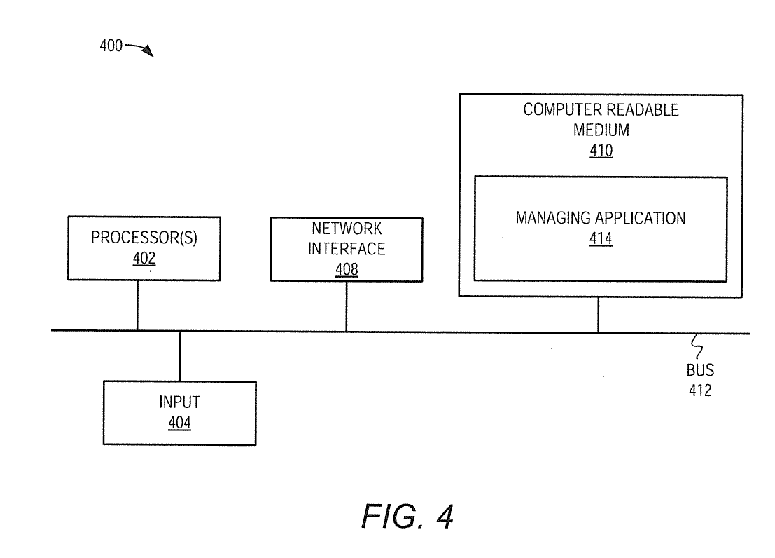

Turning now to FIG. 4, there is shown a schematic representation of an electronic device 400, which may be employed to perform various functions of the wireless communication apparatus 100 depicted in FIGS. 1 and 2, according to an example. The device 400 may include a processor 402, an input 404; a network interface 408, such as a Local Area Network LAN, a wireless 802.11x LAN, a 3G mobile WAN or a WiMax WAN; and a computer-readable medium 410. Each of these components may be operatively coupled to a bus 412.

The computer readable medium 410 may be any suitable medium that participates in providing instructions to the processor 402 for execution. For example, the computer readable medium 410 may be non-volatile, media, such as an optical or a magnetic disk; volatile media, such as memory. The computer-readable medium 410 may also store a managing application 414, which may include the modules of the managing apparatus 102 depicted in FIG. 1. In this regard, the managing application 414 may include the wireless communication apparatus geographic location determining module 104, the installation geographic location determining module 106, the geographic location comparing module 108, and the channel usage management module 110.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method of managing use of a predetermined channel by a wireless communication apparatus, said method comprising:
determining a geographic location of the wireless communication apparatus;
determining a geographic location of an installation at which use of the predetermined channel is authorized, wherein the predetermined channel corresponds to a predetermined range of frequencies that are restricted for public use;
determining whether the wireless communication apparatus is outside of a predefined distance from the installation;
in response to a determination that the wireless communication apparatus is outside of the predefined distance, allowing use, by the wireless communication apparatus, of the predetermined channel; and
in response to a determination the wireless communication apparatus is within the predetermined distance, restrict use by the wireless communication apparatus of the predetermined channel.

2. The method according to claim 1, wherein the installation comprises an installation including a Terminal Doppler Weather Radar (TDWR) system.

3. The method according to claim 1, further comprising:
accessing a publicly accessible database that lists geographic locations of a plurality of installations at which use of the predetermined channel corresponding to the predetermined range of frequencies is authorized and wherein determining the geographic location of the installation further comprises determining the geographic location of the installation from the publicly accessible database.

4. The method according to claim 1, wherein determining the geographic location of the wireless communication apparatus further comprises determining the geographic location of the wireless communication apparatus from location information identified by a global positioning system.

5. The method according to claim 1, wherein the wireless communication apparatus comprises a wireless access point, said method further comprising:
communicating with a client device using the predetermined channel in response to a determination that the wireless access point is outside of the predefined distance.

6. A wireless communication apparatus comprising:
a processor;
a memory on which is stored machine readable instructions that cause the processor to:
determine a geographic location of the wireless communication is apparatus;
determine a geographic location of an installation at which use of a predetermined channel corresponding to a predetermined range of frequencies is authorized;
determine whether the wireless communication apparatus is outside of a predefined distance with respect to the installation; and
in response to a determination that the wireless communication apparatus is outside of the predefined distance, enabling use of the predetermined channel to communicate signals wirelessly.

7. The wireless communication apparatus according to claim 6, wherein the machine readable instructions are further to cause the processor to:
in response to the wireless communication apparatus being inside of the predefined distance, restrict use of the predetermined channel.

8. The wireless communication apparatus according to claim 6, wherein the installation comprises an installation including a Terminal Doppler Weather Radar (TDWR) system and wherein the predetermined channel comprises one of wireless local area network (WLAN) channels 120, 124, and 128.

9. The wireless communication apparatus according to claim 6, wherein, to determine the geographic location of the installation, the machine readable instructions are to cause the processor to access a publicly accessible database that lists geographic locations of a plurality of installations at which use of the predetermined channel corresponding to the predetermined range of frequencies is to authorized.

10. The wireless communication apparatus according to claim 6, further comprising:
a location identifying device to automatically identify the geographic location of the wireless communication apparatus, wherein the processor is to access the geographic location of the wireless communication apparatus identified by the location identifying device to determine the location of the wireless communication apparatus.

11. The wireless communication apparatus according to claim 6, wherein the location identifying device comprises a global positioning system (GPS) device.

12. The wireless communication apparatus according to claim 6, wherein the predefined distance with respect to the installation is approximately 30 miles.

13. The wireless communication apparatus according to claim 6, wherein the wireless communication apparatus comprises a wireless access point.

14. A non-transitory computer readable storage medium on which is stored machine readable instructions that when executed by a processor are to cause the processor to:
determine a geographic location of a wireless communication apparatus;
determining a geographic location of an installation at which use of a predetermined channel is authorized;
determining whether the wireless communication apparatus is outside of a predefined distance from the installation;
in response to a determination that the wireless communication apparatus is outside of the predefined distance, allow the wireless communication apparatus to use the predetermined channel to communicate signals wirelessly; and
in response to a determination the wireless communication apparatus is within the predetermined distance, restrict use of the predetermined channel by the wireless communication apparatus.

15. The non-transitory computer readable storage medium according to claim 14, wherein the installation comprises an installation having a Terminal Doppler Weather Radar (TDWR) system.
